(19) United States
(12) Patent Application Publication
(10) Pub. No.: US 2022/0179938 A1
(43) Pub. Date: Jun. 9, 2022

(54) EDGE MODELS

(71) Applicant: Hewlett-Packard Development Company, L.P., Spring, TX (US)

(72) Inventor: Rafael Dal Zotto, Porto Alegre (BR)

(73) Assignee: Hewlett-Packard Development Company, L.P., Spring, TX (US)

(21) Appl. No.: 17/599,589

(22) PCT Filed: Jul. 24, 2019
(86) PCT No.: PCT/US2019/043201

§ 371 Date: Sep. 29, 2021

(51) Int. Cl. G06F 21/36

(52) U.S. Cl. CPC G06F 21/36; G06F 2221/2133

(57) ABSTRACT

An example system may include a processor and a non-transitory machine-readable storage medium storing instructions executable by the processer to transmit, to an edge device, a model to predict an identity of a drawn input; transmit, to the edge device, instructions to cause the edge device to: generate a challenge corresponding to the model, apply the model to a response to the challenge to generate an output, and determine whether the response is generated by a human based on the output; and determine whether to grant the edge device access to a remote resource based on the determination of whether the response is generated by a human.

### BACKGROUND

Computing devices may be connected to a computing network. A computing network may facilitate communication and the sharing of resources among connected computing devices. For example, data stored at a first computing device may be accessed by a second computing device utilizing a computing network. In some examples, access to the data on a computing device may be limited. For example, a system may be utilized to protect data from being accessed by automated systems such as bots.

### BRIEF DESCRIPTION OF THE DRAWINGS

FIG. 1 illustrates an example of a system for utilizing edge models to determine whether a response is generated by a human consistent with the present disclosure.

FIG. 2 illustrates an example of an access control device for utilizing edge models to determine whether a response is generated by a human consistent with the present disclosure.

FIG. 3 illustrates an example of a non-transitory machine-readable memory and processor for utilizing edge models to determine whether a response is generated by a human consistent with the present disclosure.

FIG. 4 illustrates an example of a method for utilizing edge models to determine whether a response is generated by a human consistent with the present disclosure.

### DETAILED DESCRIPTION

A computing device connected to a computing network may be able to access any number of remote resources over the computing network. For example, a computing device may be able to access data, services, and/or applications hosted on other computing devices by utilizing the computing network.

For example, a computing device may be able to engage with a service, a website, a data store, an application, etc. that is hosted by a remote computing device such as a server. However, those remote resources may face attacks from automated systems such as bots. A bot may include a set of instructions executable by a processor to perform a script of automated tasks at a much higher rate than would be possible for a human alone. In some examples, these automated systems may be utilized to perform unpermitted data harvesting, consume bandwidth, consume services, scrape content, conduct a denial-of-service attack, pollute a data store, etc.

In some examples, access to a remote resource may be protected by a security measure. An example of a security measure may include a Turing test-based security measure. A Turing test may include a test to determine if a behavior is performed by and/or is indistinguishable from the behavior of a human. For example, access to a remote resource across a computing network may be predicated on a user solving a completely automated public Turing test to tell computers and humans apart (CAPTCHA). Variants of the CAPTCHA such as NoCAPTCHA/ReCaptcha Reboot, reCAPTCHA, Text CAPTCHA, Logic Questions and Image Recognition, etc. may be utilized to protect access to the remote resource.

For example, a user of a computing device may be presented with graphically encoded human-readable text challenge. The challenge may be generated by a remote server. The challenge may include data that the user is expected to accurately report back to the remote server. The accuracy of the report back to the remoter server may then be utilized by the remote server to distinguish a human user from an automated system. If the text reported back to the remote server is the same text that the remote server presented in the challenge, then the user may be judged to be human and may be permitted access to the remote resource. However, if the text reported back to the remote server is not the same text that the remote server presented in the challenge, then the user may be judged to be an automated system and denied access to the remote resource.

As described above, CAPTCHA techniques may rely on generating challenges at a remote resource, sending the challenges over the computing network to a computing device requesting access to the remote resource, sending the response to the challenge back over the computing network to the remote resource for analysis, analyzing the response at the remote resource, and waiting for a response from the remote resource to indicate that access to the remote resource is granted. As such, these CAPTCHA techniques may contribute to network congestion, strain the computational capacity of remote computing devices, and involve wait times associated with communicating the CAPTCHA data back and forth across the computing network.

In contrast, examples consistent with the present disclosure may differentiate between human users and automated systems at an edge device of a computing network. Examples consistent with the present disclosure may utilize edge models to determine whether the edge device will be granted access to a remote resource. Examples consistent with the present disclosure may include a system including a processor and a non-transitory machine-readable medium storing instructions executable by the processor to transmit, to an edge device, a model to predict an identity of a drawn input. The instructions may be executable by the processor to transmit, to the edge device, instructions to cause the edge device to: generate a challenge corresponding to the model, apply the model to a response to the challenge to generate an output, and determine whether the response is generated by a human based on the output. The instructions may be executable by the processor to determine whether to grant the edge device access to a remote resource based on the determination of whether the response is generated by a human.

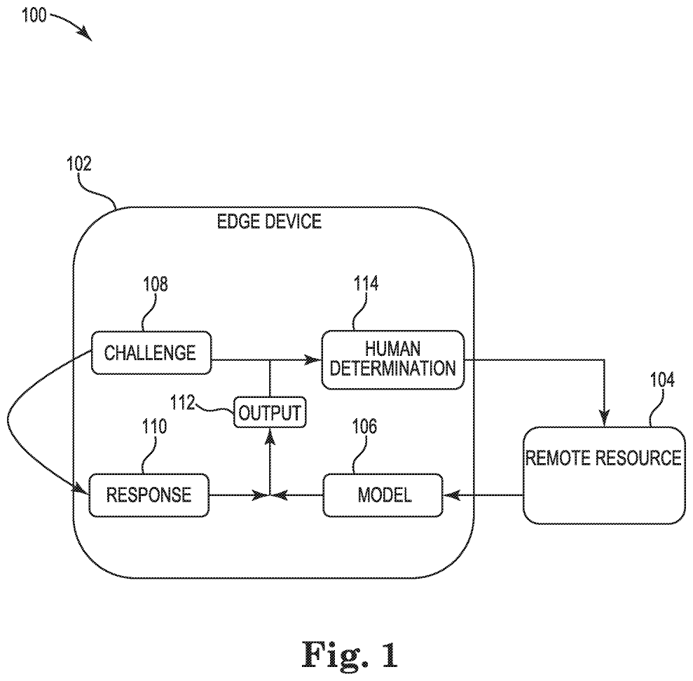

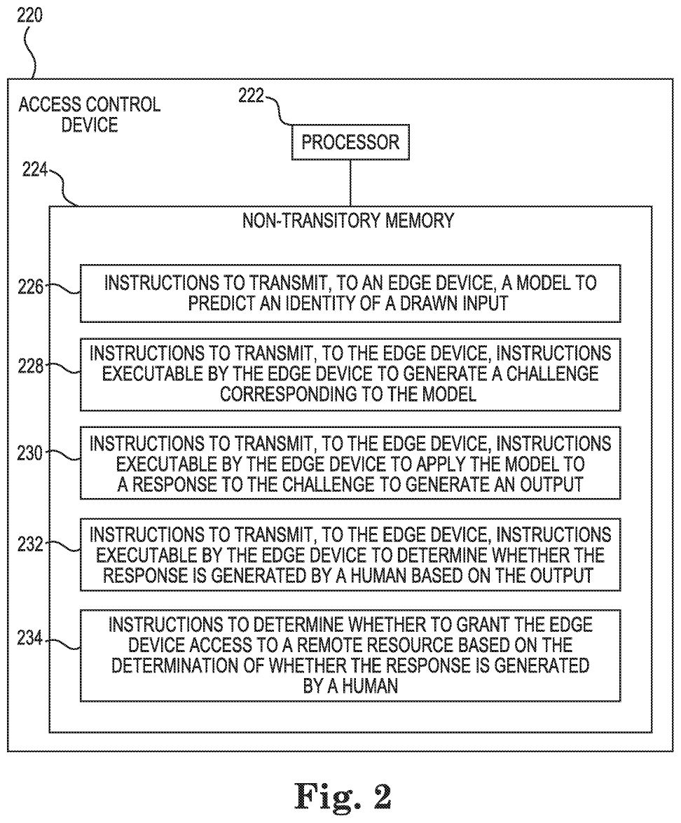

FIG. 1 illustrates an example of a system 100 for utilizing edge models to determine whether a response is generated by a human consistent with the present disclosure. The described components and/or operations of the system 100 may include and/or be interchanged with the described components and/or operations described in relation to FIG. 2-FIG. 4.

The system 100 may include an edge device 102. The edge device 102 may be a computing device. For example, the edge device 102 may include a laptop computer, a desktop computer, a smartphone, a tablet, a wearable computing device, a smart device, an Internet-of-things (IOT) device, a router, an access point, a hotspot, a server, a notebook computer, etc. The edge device 102 may include a processor to execute instructions in order to perform operations. The edge device 102 may include non-transitory machine-readable storage medium that stores instructions executable by the processor to perform the operations.

The edge device 102 may be connected to a remote resource 104 via a computing network. For example, the edge device 102 may be connected to a remote resource 104 via the Internet. The edge device 102 may be connected to the Internet via a personal area network, a local area network, a metropolitan area network, a wide area network, etc. In some examples, the edge device 102 may be connected Wi-Fi network connections, cellular data connections, etc.

Despite being communicably coupled via the computing network, the remote resource 104 may be physically separate and/or remote from the edge device 102. That is, the remote resource 104 may be distinct from the edge device 102.

The remote resource 104 may include a computing device, a server, a data center, a distributed cloud computing component, a data store, etc. The remote resource 104 may include a device that hosts a service, data, a website, an application, a web application, etc. that is accessible to other computing devices over the computing network. For example, the remote resource 104 may include a web server.

The remote resource 104 may include and/or be associated with a remote computing device. The remote resource 104 may include a processor to execute instructions in order to perform operations. The remote resource 104 may include non-transitory machine-readable storage medium that stores instructions executable by the processor to perform the operations. The processor, the non-transitory machine-readable storage medium, and/or the instructions of the remote resource 104 may be separate from the processor, the non-transitory machine-readable storage medium, and/or the instructions of the edge device 102.

The edge device 102 may include a client device which may act as a client or consumer of the service, the data, the website, the application, the web application, etc. hosted by the remote resource 104. The edge device 102 may be a computing device that a user directly utilizes to access the computing network. The edge device 102 may be located at the logical “edge” of a computing network. For example, the edge device 102 may be operated as a client node at the interface between the computing network and the real world. That is, the edge device 102 may provide a user an entry point to a computing network. The edge device 102, for example, may be a smartphone device of a user of a social networking website and the remote resource 104 may be a web server of the social networking website.

As described above, the edge device 102 and the remote resource 104 may be communicably coupled via a computing network. The edge device 102 and the remote resource 104 may communicate with one another across a network connection. In some examples, the edge device 102 may include an application executable at the edge device 102. An application may include a set of instructions executable by the processor of the edge device 102 to perform a set of operations. For example, the edge device 102 may include an application executable by the processor of the edge device 102 to access remote resources such as remote resource 104 across a computing network. For example, the edge device 102 may include an application executable to operate as a web browser to access remote resources utilizing the network connection.

However, other application types executable at the edge device 102 are contemplated as well. For example, the application may be a desktop graphical user interface (GUI) application which may utilize web technologies in its execution without operating as a web browser. For example, the application may be based on an ElectronJS framework or another framework application executing at the edge device 102.

The application executable by the processor of the edge device 102 to access remote resources may support running Javascript during its execution. Applications that support programming languages other than Javascript in their execution are contemplated as well. For example, application executable by the processor of the edge device 102 may support running any other programming language, such as Python, etc. during its execution. That is, the JavaScript examples is not meant to limit the disclosure as any other programming that may be utilized for application execution by the processor at the edge device 102 is additionally contemplated herein.

Unlike systems that rely entirely on the remote resource 104 to generate a challenge, analyze a response to a challenge, and determine remote resource access permissions, the system 100 may cause the edge device 102 to perform such operations. As such, the system 100 may provide increased network performance and decreased delays in accessing remote resources.

For example, a request to access the remote resource 104 may be generated at the edge device 102. A request to access the remote resource 104 may include a request to access data, services, websites, applications, web applications, etc. hosted by and/or stored at the remote resource 104.

The request to access the remote resource 104 may be transmitted to the same remote resource that hosts the data, services, websites, applications, web applications, etc. or the request to access the remote resource 104 may be transmitted to a different remote resource than the one that hosts the data, services, websites, applications, web applications, etc. For example, the request to access the remote resource 104 may be transmitted to a remote resource that handles access control for the remote resource hosting the data, services, websites, applications, web applications, etc. being requested. That is, while FIG. 1 depicts a single remote resource 104 component, it is contemplated that the illustration may additionally be interpreted as including more than one remote resource, component in box 104 and/or that the remote resource 104 may be distributed over a plurality of components.

A user of the edge device 102 may request access to a remote resource 104. In examples where the edge device 102 includes an application, executable at the edge device 102 to search for and/or communicate with remote resources, a user may submit a request to access the remote resource 104 via the application.

In some examples, the request to access the remote resource 104 may be communicated to the remote resource 104 from the edge device 102. The request to access the remote resource 104 may be communicated from the edge device 102 to the remote resource 104 over an active network connection. For example, the request to access the remote resource 104 may be communicated from the application, executable at edge device 102, over an active network connection.

Responsive to the request to access the remote resource 104 being generated and/or being communicated to the remote resource 104, a mechanism to protect access to the remote resource 104 may be triggered. The mechanism may protect access to the remote resource 104 by utilizing edge models to differentiate between human access requests and access requests from an automated system and limiting access accordingly.

For example, a model 106 may be transmitted to the edge device 102. The model 106 may be transmitted from the remote resource 104 to the edge device 102 via a network connection. The model 106 may include a model to predict an identity of a drawn input. The model 106 may be trained, prior to being transmitted to the edge device 102, to analyze an input hand drawn (e.g., on a touch screen, on a touch pad, using a stylus, using a mouse, etc.) by a user at the edge device 102. The model may be applied to the hand drawn input to classify that input as a particular one of a plurality of characters that the model 106 is trained to identify.

For example, the model 106 may include a model that was trained, prior to transmission to the edge device 102, using a convolutional neural network based on the Modified National Institute of Standards and Technology (MNIST) database of handwritten digits. This example is not meant to limit the disclosure as any other database that may be utilized for training various image processing systems is additionally contemplated. Any pre-trained model may be utilized. A model considered state-of-the-art may be utilized. Additionally, different models may be swapped between at any time.

In addition to and/or along with the model 106, a framework may be transmitted to the edge device 102. The framework may include the instructions to apply the model 106 to an input. For example, the framework may include a library for training and deploying machine learning models at the edge device 102. In some examples, the framework may include a library for training and deploying machine learning models in the application executable by the processor of the edge device 102 to access remote resources such as remote resource 104. For example, the framework may include a JavaScript, or other programming language, library for training and deploying machine learning models in the application executable by the processor of the edge device 102 to access remote resource 104. An example of a framework that may be transmitted may include a TensorFlow.js JavaScript library for training and deploying machine learning models in a web browser executing on the edge device 102.

The framework may allow the edge device 102 to independently run convert a pretrained model 106 from Python, for example, and load it into a JavaScript, for example, based solution. As such, the framework may allow the model 106 to be executed directly on the edge device 102. For example, the framework may allow the model 106 to run directly in an application executable by the processor of the edge device 102 to access remote resource 104. The framework may include the instructions that allow the model 106 to be applied to user input to predict an identity of a drawn input at the edge device 102, for example, within an application executing at the edge device 102.

The framework may be transmitted to the edge device 102 from the same source as the model 106. That is, the model 106 and the framework may be transmitted to the edge device 102 from a common source, such as remote resource 104. The edge device 102 may lack the model 106 and/or the framework prior to receiving their transmission.

Instructions may be transmitted to the edge device 102 to cause the edge device 102 to perform various operations associated with differentiating between a human and an automated system. The instructions may include instructions to cause the edge device 102 to generate a challenge 108.

The challenge 108 may include a message to a user of the edge device 102 that is designed to elicit a specific response. For example, the challenge may include instructions to complete a CAPTCHA challenge at the edge device 102. For example, the challenge 108 may include an instruction to a user to hand draw (e.g., on a touch screen, on a touch pad, using a stylus, using a mouse, etc.) a character (e.g., a letter, digit, symbol, special characters (e.g., !, @, #, $, %, \hat{ }, &, *, _, etc.), and others) at the edge device 102. The challenge 108 may correspond to the model 106. That is, the challenge 108 may provide an instruction to the user to draw a character of a plurality of characters that the model 106 is trained to predict the identity of.

The challenge 108 may specify a single character, a string of characters, a resulting combination of characters, operations to be performed to multiple characters (e.g., add two characters, subtract two characters, multiply two characters, divide two characters, etc.), etc. The challenge 108 may specify a canvas area or a portion of a canvas area of the edge device 102 where the character should be reproduced by the user. In some examples, the canvas area may include an entire user interface of the application executing by the processor of the edge device 102 to access remote resource 104. For example, the challenge 108 may instruct a user to “draw the number eight in the upper right-hand corner” of the user interface of the application executing by the processor of the edge device 102 to access remote resource 104.

The specific contents of the challenge 108 (e.g., the specific character being elicited in the challenge) may not be specified by the remote resource 104 that transmitted the model 106 to the edge device 102. Instead, the instructions to cause the edge device 102 to generate the challenge 108 may include instructions to randomly generate a character at the edge device 102 to instruct the user to hand draw in the challenge 108. As described above, the instructions to cause the edge device 102 to generate the challenge 108 may include instructions to randomly generate a character selected form a plurality of characters identifiable by the model 106. In some examples, a math object of the application executing by the processor of the edge device 102 to access remote resource 104 may be utilized to randomly select a numeric digit to be elicited in the challenge 108.

The challenge 108 may be generated by the edge device 102. For example, the challenge 108 may be generated by an object in the application executing by the processor of the edge device 102 to access remote resource 104. The challenge 108 may be presented, by the edge device 102, to a user of the edge device 102. For example, the challenge 108 may be presented to the user via text displayed on a user interface of the application executing by the processor of the edge device 102 to access remote resource 104.

A response 110 to the challenge 108 may be received at the edge device 102. The response 110 to the challenge 108 may be received in the application executing by the processor of the edge device 102 to access remote resource 104. The response 110 may be generated by a human user utilizing the edge device 102, in some examples, and by an automated system utilizing the edge device in other examples. The response 110 may include an input to the edge device 102. The input may be expected to include a hand drawn input corresponding to a character requested in the challenge 108.

The instructions transmitted to the edge device 102 may include instructions to cause the edge device 102 to apply the model 106 to the response 110 to the challenge 108. Applying the model 106 to the response 110 may include executing the model 106 over the framework to analyze the input from the response 110 in order to generate an output 112. The model 106 may be applied to the response 110 in the application executing by the processor of the edge device 102 to access remote resource 104. The output 112 may be generated at the edge device 102.

For example, the drawn input from the response 110 may be analyzed using the model 106 to generate a prediction of an identity of a drawn character in a response 110. That is, the response 110 may be analyzed at the edge device 102 using the model 106 to produce a prediction of what is drawn in the response 110. For example, the shapes, angles, strokes, steadiness, uniformity, etc. of the inputs recorded in the response 110 may be analyzed using the model 106 to predict the identity of the drawn inputs in the response 110.

The output 112 resulting from the application of the model 106 to the response 110 may include the predicted identity of the drawn input in the response 110. The output 112 (e.g., the predicted identity of the drawn input in the response 110) may be generated without reference to an identity of the randomly selected character the user was instructed to draw by the challenge 108. That is, the edge device 102 may apply the model 106 to the response 110 to generate the output 112 without knowledge of the identity of the character posed in the challenge 108. The prediction of the identity of the drawn input in the response 110 may be done independent of and/or without influence from the identity of the randomly selected character the user was instructed to draw by the challenge 108.

The instructions transmitted to the edge device 102 may include instructions to cause the edge device 102 to generate a human determination 114. A human determination 114 may include a determination whether the response 110 was generated by a human or was generated by an automated system. The human determination 114 may be performed in the application executing by the processor of the edge device 102 to access remote resource 104.

The human determination 114 whether the response 110 is generated by a human or an automated system may be based on a comparison between the output 112 (e.g., the predicted identity of the drawn input in the response 110) and the identity of the randomly selected character that the user was instructed to draw in the challenge 108. That is, although the predicted identity of the drawn input in the response 110 was determined independent of any reference to the randomly selected character that the user was instructed to draw in the challenge 108, it may now be compared against it to generate the human determination 114. If the predicted identity of the drawn input in the response 110 is found to match the identity of the randomly selected character that the user was instructed to draw in the challenge 108, then the response may be determined to have been generated by a human. If, on the other hand, the predicted identity of the drawn input in the response 110 is found to not match the identity of the randomly selected character that the user was instructed to draw in the challenge 108, then the response may be determined to be either an incorrect response 110 to the challenge 108 by a human user or a response 110 generated by an automated system.

Since the edge device 102 is provided with the model 106, the framework, and the instructions to generate a challenge corresponding to the model; apply the model to a response to the challenge to generate an output; and determine whether the response is generated by a human based on the output, the edge device 102 may perform the operations described herein independently and/or without the use of additional service or components. As such, the edge device 102 may generate a challenge corresponding to the model; apply the model to a response to the challenge to generate an output; and determine whether the response is generated by a human based on the output in the absence of an active network connection. That is, the edge device 102 may perform such operations without being able to communicate with the remote resource 104. The edge device 102 may be communicably isolated from the computing network and still successfully perform these operations. For example, since the model 106 may be incorporated as part of the application executing by the processor of the edge device 102 to access remote resource 104, inferences may be run on top of the application without utilizing remote resources and network connections.

A determination may be made whether to grant the edge device 102 access to the requested remote resource 104 based on the human determination 114. That is, the user of the edge device 102, the edge device 102, and/or the application executing by the processor of the edge device 102 to access remote resource 104 may be granted or denied access to the remote resource 104 based on whether the response 110 to the challenge 108 was determined to have been generated by a human or by an automated system, as described above. In instances where the human determination 114 is that the response was generated by a human, then the user of the edge device 102, the edge device 102, and/or the application executing by the processor of the edge device 102 to access remote resource 104 may be granted access to the remote resource 104. In instances where the human determination 114 is that the response was generated by an automated system or is an erroneous human response, then the user of the edge device 102, the edge device 102, and/or the application executing by the processor of the edge device 102 to access remote resource 104 may be denied access to the remote resource 104 and/or the edge device 102 may generate a new challenge. In this manner, access to the remote resource 104 by automated systems may be limited.

Again, although the remote resource 104 is illustrated as a single component, it is additionally contemplated that the remote resource 104 may include a plurality of remote resources, devices, data locations, etc. For example, the request to access a remote resource 104 may be received at a first remote resource, device, or data location. Meanwhile, a second remote resource, device, or data location may provide the aforementioned model 106. Further, a third remote resource, device, or data location may include the actual data requested to be accessed by the edge device 102.

FIG. 2 illustrates an example of an access control device 220 for utilizing edge models to determine whether a response is generated by a human consistent with the present disclosure. The described components and/or operations of the access control device 220 may include and/or be interchanged with the described components and/or operations described in relation to FIG. 1 and FIG. 3-FIG. 4.

The access control device 220 may include a computing device. For example, the access control device may include a processor 222 and/or a non-transitory memory 224. The non-transitory memory 224 may include instructions (e.g., 226, 228, 230, 232, 234, etc.) that, when executed by the processor 222, cause the access control device 220 to perform various operations described herein. While the access control device 220 is illustrated as a single component, it is contemplated that the access control device 220 may be distributed among and/or inclusive of a plurality of such components.

The access control device 220 may include a server. For example, the access control device 220 may include an access control server (ACS) that may provide and/or host authentication and/or authorization services. For example, the access control device 220 may include an ACS that controls access to a resource such as data, applications, storage, services, etc. In some examples, the resource for which it controls access may be hosted on the access control device 220. In some examples, the resource for which it controls access may be hosted on a different server, device, and/or location. In some examples, the resource for which it controls access may be distributed among a plurality of servers, devices, and/or locations.

The access control device 220 may receive, or otherwise detect, a request to access the resource for which it controls access. Responsive to such a request, the access control device may initiate a test of whether the request is originating from a human user of an edge device. The access control device 220 may initiate the test by executing the instructions (e.g., 226, 228, 230, 232, 234, etc.) stored in the non-transitory memory 224 with its processor 222.

The access control device 220 may execute instructions 226 to transmit, to an edge device, a model to predict an identity of a drawn input. That is, the access control device 220 may send a model, pretrained to predict a character represented by a drawn input. In addition, the access control device 220 may transmit a framework to apply the model to a drawn input at the edge device. That is, the access control device may send the edge device everything to execute, at the edge device, the test of whether a request from the edge device is originating from a human user of the edge device. In some examples, the model and/or the framework may be sent from the access control device 220 to an edge device over a computing network.

The edge device may include an application executable to provide the edge device with access to remote resources. The access control device 220 may provide the model and/or the framework as components that are expressed in and/or convertible to a programming language supported by the application, such that the components are able to run directly in the application and rely on the processing resources of the edge device for their execution.

The access control device 220 may execute instructions 228 to transmit, to the edge device, instructions executable by the edge device to generate a challenge corresponding to the model. For example, the edge device may be instructed to challenge a user of the edge device to draw a character at the edge device that is identifiable by the model. The instructions may not specify which character the challenge should propose but may instead cause the edge device to randomly generate a character from among a plurality of characters represented in the model. The challenge may be presented to a user of the edge device via a display or other communication of the challenge to the user via the edge device.

In some examples, the instructions to generate a challenge corresponding to the model may be sent from the access control device 220 to an edge device over a computing network. However, the edge device may execute the instructions to generate a challenge corresponding to the model without an active network connection and/or other communication path to the access control device 220 or other devices. For example, the instructions to generate a challenge corresponding to the model may be run directly in the application executing at the edge device and may rely on the processing resources of the edge device without utilizing a network connection.

The access control device 220 may execute instructions 230 to transmit, to the edge device, instructions executable by the edge device to generate apply the model to the response to the challenge to generate an output. For example, the model may be executed over the framework at the edge device to analyze any input included in a response to the challenge.

Applying the model to the response may include importing the convolutional neural network pre-trained to identify drawn characters, converting the pre-trained neural network to a second programming language executable over the framework within the application executing at the edge device, and utilizing the pre-trained neural network executing over the framework to issue an output. The output may include a prediction of an identity of a drawn character featured in the response to the challenge. The instructions to apply the model to the response to the challenge to generate an output may be run directly in the application executing at the edge device and may rely on the processing resources of the edge device without utilizing a network connection.

The access control device 220 may execute instructions 232 to transmit, to the edge device, instructions executable by the edge device to determine whether the response is generated by a human based on the output. For example, the instructions 228 may be executable by the edge device to compare the output, a prediction of an identity of a drawn character featured in the response to the challenge to the identity of the actual character requested to be drawn in the challenge. If a match is found, then the response and/or the request to access remote resource may be determined to have originated from a human user. If no match is found, then the response and/or the request to access remote resource may be determined to have originated from an automated system or be an erroneous response by a human user. The instructions to determine whether the response is generated by a human based on the output may be run directly in the application executing at the edge device and may rely on the processing resources of the edge device without utilizing a network connection.

The access control device 220 may execute instructions 234 to determine whether to grant the edge device and/or the user thereof access to the remote resource for which it controls access. The determination of whether to grant the edge device and/or the user thereof access to the remote resource may be based upon the determination, by the edge device, of whether the response is generated by a human based on the output. For example, if the response and/or the request to access the remote resource is determined to have originated from a human user, then the edge device and/or user thereof may be granted access to the remote resource by the access control device 220. However, if the request to access the remote resource is determined to have originated from an automated system and/or be an erroneous response by a human user, then access to the remote resource may be restricted by the access control device 220 and/or instructions executable by the edge device to generate another challenge may be transmitted to the edge device.

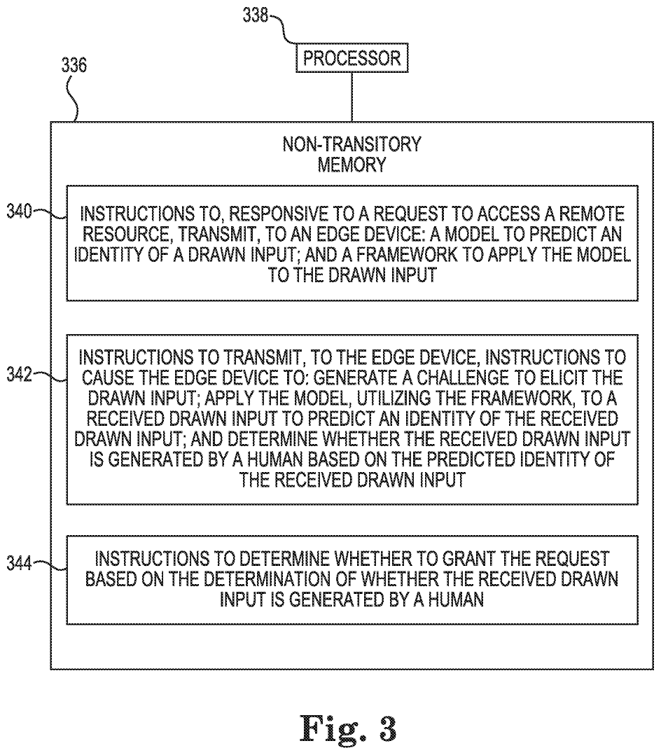

FIG. 3 illustrates an example of a non-transitory machine-readable memory and processor for utilizing edge models to determine whether a response is generated by a human consistent with the present disclosure. A memory resource, such as the non-transitory machine-readable memory 336, may be utilized to store instructions (e.g., 340, 342, 344, etc.). The instructions may be executed by the processor 338 to perform the operations as described herein. The operations are not limited to a particular example described herein and may include and/or be interchanged with the described components and/or operations described in relation to FIG. 1-FIG. 2 and FIG. 4.

The non-transitory memory 336 may store instructions 340 executable by the processor 338 to transmit, to an edge device, a model to predict an identity of a drawn input and a framework to apply the model to the drawn input. The model and the framework may be transmitted to the edge device responsive to a request, generated at the edge device, to access a remote resource.

The model may include a pre-trained machine learning model that may accept drawn inputs as an input, analyze the input devoid of an indication of an expectation of an identity of the input, and predict an identity of the input. The predicted identity of the input may include an identity from among a plurality of identities that the model is pre-trained to recognize. For example, the shape of the input may be compared to shapes of a set of input identities that the model has been trained to identify in order to find a corresponding shape.

The input may be hand drawn and, as a result, highly-variable from user to user, but the model may be able to analyze characteristics of the input to predict the identity intended by the user and/or whether the manner in which the input was entered into the edge device (e.g., the stroke length, number of mouse clicks, range of motion used to input, how perfect or imperfect the strokes and resulting shapes are entered, the length of time over which the input was entered, the portion of the canvas that the input was entered at, etc.) is consistent with a human having provided the input. For example, when a human draws a character, the human's hand may have a slight shake or tremor while drawing. As such, the lines drawn by the human may exhibit imperfections. In contrast, an automated system reproducing a character may not exhibit these imperfections and the lines it produces may be entirely uniform and/or consistent (e.g., perfect). In some examples, the model may be able to analyze the input and determine whether the input exhibits imperfections consistent with human input or if the input is too perfect consistent with an automated system.

The framework may include the instructions to deploy the model within an application at the edge device. That is, the model may be applied to an input to issue the input identity prediction utilizing the provided framework within an application executing at the edge device. As such, once the model and framework are transmitted to the edge device, the model and framework may be utilized in the operations described herein without an active network connection.

The non-transitory memory 336 may store instructions 342 executable by the processor 338 to transmit, to the edge device, instructions to cause the edge device to utilize edge models to determine whether a response is generated by a human. The instructions transmitted to the edge device may include instructions to generate a challenge to elicit the drawn input. For example, the instructions transmitted to the edge device may include instructions to cause the edge device to randomly select a character, of a plurality of characters identifiable by the model, to request the user of the edge device to draw at the edge device in order to verify that they are a human and not an automated system.

The instructions transmitted to the edge device may include instructions to cause the edge device to apply the model, utilizing the framework, to a received drawn input. That is, the edge device may receive a response to the challenge it generated. The response may include a hand drawn input to the edge device from the user. This input may be analyzed by the model executed over the framework within an application executing at the edge device. That is, the processor of the edge device and the application executing at the edge device may be utilized to analyze the input utilizing the model executed over the framework.

Applying the model to the received drawn input may include generating, by applying the model, an output from the received drawn input. The output may include a prediction of an identity of the received drawn input generated by using the model to analyze potential identities of the received drawn input.

For example, once a user ends drawing the challenged drawn input, the content of a canvas designated to receive the drawn input may be extracted. The extracted content may be converted from pixels into a float representation or a numeric representation of the drawn input. The extracted content and/or the float representation or numeric representation of the extracted content may be utilized as an input to be analyzed by the model. In such examples, the framework transmitted to the edge device may include a machine learning library for applying the model to the extracted content and/or the float representation or numeric representation of the extracted content of the received drawn input to generate a prediction regarding the received drawn input.

For example, the prediction may include a prediction of the identity of the received drawn input. Applying the model to the received drawn input may generate a prediction that the identity of the received drawn input is each one of a plurality of characters identifiable by application of the model to an input.

For example, applying the model to the received drawn input may generate a prediction of a likelihood score that the identity of the received drawn input is accurately identified as each one of a plurality of characters identifiable by application of the model to an input. The likelihood score may be generated by the edge device based on a percentage fit of each character identifiable in the model to the received drawn input. In examples where the model may identify hand drawn digits as one of the digits zero through nine, applying the model to the received drawn input may generate a prediction of a likelihood that the received drawn input is the character zero, a prediction of a likelihood that it is the character one, a prediction of a likelihood that it is the character two, and so on up to character nine.

The instructions transmitted to the edge device may include instructions to cause the edge device to determine whether the received drawn input is generated by a human based on the predicted identity of the received drawn input. For example, the edge device may compare the prediction of the identity of the received drawn input, output from applying the model to the received drawn input, to the identity of the drawn input that was specified to be drawn by the challenge. That is, the edge device may compare the prediction of the identity of the received drawn input to what is was supposed to be as per the challenge.

In examples where applying the model to the received drawn input generates a prediction of a likelihood score that the identity of the received drawn input is accurately identified as each one of a plurality of characters identifiable by application of the model to an input, the predicted character of the plurality of characters identifiable by the model, that is associated with a highest likelihood of accurately identifying the received drawn input may be the predicted character that is selected for comparison to the drawn input that was specified to be drawn by the challenge. That is, if the received drawn input has a highest likelihood of its identity being accurately predicted as a number eight among the potential numbers zero through nine, then the number eight may be compared to what is was supposed to be as per the challenge.

If the predicted identity of the received drawn input matches the identity of the drawn input that was specified to be drawn by the challenge, then the received drawn input may be determined to have been generated by a human. If the identity of the received drawn input does not match the identity of the drawn input that was specified to be drawn by the challenge, then the received drawn input may be determined to have been generated by an automated system and/or be an erroneous input from a human.

The non-transitory memory 336 may store instructions 344 executable by the processor 338 to determine whether to grant the request of the edge device to access the remote device. The determination whether to grant the request may be based on the determination of whether the received drawn input is generated by a human. For example, if a human is determined to have generated the received drawn input, then the request may be granted. Conversely, if an automated system is determined to have generated the received drawn input or if the received drawn input is determined to be an erroneous human input then the request may be denied.

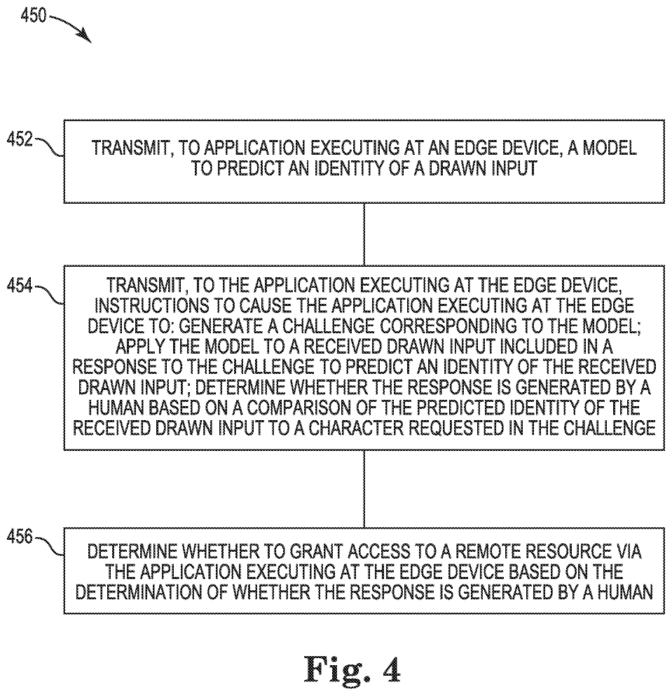

FIG. 4 illustrates an example of a method for utilizing edge models to determine whether a response is generated by a human consistent with the present disclosure. The described components and/or operations of method 450 may include and/or be interchanged with the described components and/or operations described in relation to FIG. 1-FIG. 3.

At 452, the method 450 may include transmitting, to an edge device, a model to predict an identity of a drawn input. The model may include a pre-trained machine learning model that may be executed over a framework at the edge device to identify a hand drawn input at the edge device. The model and/or the framework may be transmitted to an application executing at the edge device. The model and the framework may be utilized within the application to predict the identity of the hand drawn input. The model and the framework may run in the application utilizing the processing resources of the edge device and may be executed without utilizing a network connection.

At 454, the method 450 may include transmitting, to the application executing at the edge device, instructions to cause the application executing at the edge device to utilize edge models to determine whether a response is generated by a human consistent with the present disclosure. For example, instructions transmitted to the application executing at the edge device may include instructions to cause the application executing at the edge device to generate a challenge corresponding to the model.

Generating a challenge corresponding to the model may include randomly generating, by the application executing at the edge device, a character to challenge a user to reproduce at the edge device. The character may be a randomly selected character from a plurality of characters identifiable by application of the model.

The challenge may include a specific character/s to be reproduced. The challenge may include additional challenge elements to further specify and/or complicate the reproduction of the specific characters. For example, the challenge may specify a canvas where the specific character should be reproduced at the edge device. For example, a user interface of the application executing at the edge device may be utilized as the canvas where the specific character is to be reproduced. The challenge may specify a particular portion or portions of the user interface of the application executing at the edge device where the specific character should be reproduced. The particular portion or portions where the specific character should be reproduced may reference general areas of the canvas. For example, the challenge may specify “hand draw the number 145 in the lower right hand corner of the user interface” or “hand draw the number 4 in the lower right hand corner of the user interface and hand draw the letter B in the upper left hand corner of the user interface.” In some examples, the particular portion or portions where the specific character should be reproduced may not be so specific that they amount to little more than tracing of the specific character.

The specific character to be included in the challenge and/or the additional challenge elements may be randomly generated by the application executing at the edge device. A remote device associated with the remote resource attempting to be accessed may not be informed of or influence the contents of the challenge.

The instructions transmitted to the application executing at the edge device may include instructions to cause the application executing at the edge device to apply the model to a received drawn input included in a response to the challenge. The model may be applied to the received drawn input within the application executing at the edge device. The application of the model to the received drawn input may yield a prediction of an identity of the received drawn input. For example, applying the model to the received drawn input may produce a prediction of the identity of a character that the received drawn input is illustrating.

In addition, applying the model to the received drawn input may generate predictions corresponding to the previously described additional challenge elements. For example, applying the model to the received drawn input may generate a prediction regarding the identity of a portion of the canvas (e.g., user interface of application executing at the edge device) where the drawn input was entered at the edge device.

The instructions transmitted to the application executing at the edge device may include instructions to cause the application executing at the edge device to determine whether the response is generated by a human based on a comparison of the predicted identity of the received drawn input to a character requested in the challenge to be reproduced by the user. That is, the predicted identity of the received drawn input may be compared to the known identity of the character that the user was asked to reproduce in the challenge.

In addition, the predicted additional factors may be compared to the known identity of the additional factors that the user was asked to reproduce in their response to the challenge. For example, the prediction of the portion of the canvas where the received drawn input was entered may be compared to the portion of the canvas that was specified as the area where the character was to be reproduced.

The determination of whether the response is generated by a human may be based on the results of the above described comparison. For example, if the predicted identity of the received drawn input matches the known identity of the character that the user was asked to reproduce in the challenge, then the application executing at the edge device may determine that the response was generated by a human. If the predicted identity of the received drawn input does not match the known identity of the character that the user was asked to reproduce in the challenge, then the application executing at the edge device may determine that the response was generated by an automated system or was an erroneous input of a human.

At 456, the method 450 may include determining whether to grant access to a remote resource, via the application executing at the edge device, based on the determination of whether the response is generated by a human. For example, if it is determined that the response is generated by a human, then access to a remote resource, via the application executing at the edge device, may be granted. However, if it is determined that the response is generated by an automated system or an erroneous input a human, then access to a remote resource, via the application executing at the edge device, may be denied.

In some examples, a new challenge may be generated by the application executing at the edge device responsive to the predicted identity of the received drawn input not corresponding to a character proposed in the challenge. That is if it is determined that the response is generated by an automated system or an erroneous input a human, then the application executing at the edge device may generate a new challenge requesting the user to reproduce a different randomly selected character identifiable by the model.

Moreover, the method 450 may include evolving the model to personalize it to a particular user or user profile. For example, the model may modified to adapt a predicted identity corresponding to a drawn input to incorporate a consistent characteristic demonstrated in the received drawn input included in the response from a particular user that would, in the absence of the adaptation, result in a failure of the predicted identity to correspond to the character proposed in the challenge.

For example, particular human users may have physical limitations, cognitive limitations, stylistic tendencies, etc. that cause their handwritten representations of a character not to correspond to a particular character that they are attempting to reproduce. For example, a particular user may reproduce a character in a non-standard way. However, to that particular user, their handwritten representation does indeed correspond to the character proposed in a challenge.

The method 450 may include adapting the model to the idiosyncrasies of a particular users handwriting by determining that a human is indeed generating a received drawn input that is consistently not producing an accurate prediction of the character proposed in the challenge when the model is applied. For example, a determination may be made that every time a particular user, e.g., a user trying to log into a profile hosted at a remote resource, enters a drawn input meant to reproduce the number eight from a challenge, it is not predicted to be identifiable as a number eight by the model. This determination may be based on data demonstrating that when the particular user attempting to log into the profile is faced with a challenge to reproduce the number eight, the predicted identity of their drawn input consistently fails to correspond to the challenge number when applying the model.

However, when the particular user is presented with a new challenge that does not include the number eight immediately following the failed challenge, then the user consistently submits a drawn input that is predicted to correspond to the correct character specified in the challenge. As such, it may be determined that the manner in which the particular user inputs the number eight includes non-standard characteristics that take it outside of the existing model. The characteristics may be identified, and the model may then be adapted to consider the input of such characteristics as indicative of the number eight. Accordingly, future input of these characteristics may result in the model predicting that the same previously non-predictive input is predictive of the correct character posed in the challenge. The adapted model and/or adaptations to the model may be transmitted from the edge device back to an access control server to be stored in association with the corresponding user profile. Upon a next request to access the profile, the adapted model may be transmitted to the edge device.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure. Further, as used herein, “a plurality of” an element and/or feature can refer to more than one of such elements and/or features.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

What is claimed:

1. A system, comprising:
a processor, and
a non-transitory machine-readable storage medium to store instructions executable by the processor to:
transmit, to an edge device, a model to predict an identity of a drawn input;
transmit, to the edge device, instructions to cause the edge device to:
generate a challenge corresponding to the model;
apply the model to a response to the challenge to generate an output; and
determine whether the response is generated by a human based on the output; and
determine whether to grant the edge device access to a remote resource based on the determination of whether the response is generated by a human.

2. The system of claim 1, wherein the instructions transmitted to the edge device include instructions to cause the edge device to:
generate, by a web browser at the edge device, the challenge corresponding to the model;
apply, by the web browser, the model to the response to the challenge to generate the output; and
determine, by the web browser, whether the response is generated by a human based on the output.

3. The system of claim 1, wherein the instructions transmitted to the edge device are executable at the edge device in the absence of an active network connection to the edge device.

4. The system of claim 1, wherein the instructions transmitted to the edge device to cause the edge device to generate a challenge corresponding to the model include instructions to:
randomly select a character of a plurality of characters identifiable by the model, and
instruct a user to draw the randomly selected character within a canvas, at the edge device, to be utilized as the drawn input.

5. The system of claim 4, wherein the generated output includes a prediction of an identity of a drawn character included in the response, wherein the prediction is to be generated without reference to an identity of the randomly selected character the user was instructed to draw by the challenge.

6. The system of claim 5, wherein the instructions transmitted to the edge device to cause the edge device to determine whether the response is generated by the human based on the output include instructions to differentiate a human user from an automated system based on a comparison of the predicted identity of the drawn character included in the response and the randomly selected character the user was instructed to draw by the challenge.

7. A non-transitory machine-readable storage medium comprising instructions executable by a processor to:
responsive to a request to access a remote resource, transmit, to an edge device:
a model to predict an identity of a drawn input; and
a framework to apply the model to the drawn input; and
transmit, to the edge device, instructions to cause the edge device to:
generate a challenge to elicit the drawn input;
apply the model, utilizing the framework, to a received drawn input to predict an identity of the received drawn input; and
determine whether the received drawn input is generated by a human based on the predicted identity of the received drawn input; and
determine whether to grant the request based on the determination of whether the received drawn input is generated by a human.

8. The non-transitory machine-readable storage medium of claim 7, wherein the instructions transmitted to the edge device include instructions to cause the edge device to extract the received drawn input from a canvas to be utilized as the drawn input for applying the model.

9. The non-transitory machine-readable storage medium of claim 8, wherein the framework to apply the model includes a machine learning library for applying the model to the extracted received drawn input to predict a likelihood that the received drawn input is accurately identifiable as each one of a plurality of characters identifiable by the model.

10. The non-transitory machine-readable storage medium of claim 9, wherein the predicted identity of the received drawn input is a predicted character, of the plurality of characters identifiable by the model, associated with a highest likelihood of accurately identifying the received drawn input.

11. A method, comprising:
transmitting, to application executing at an edge device, a model to predict an identity of a drawn input;
transmitting, to the application executing at the edge device, instructions to cause the application executing at the edge device to:
generate a challenge corresponding to the model;
apply the model to a received drawn input included in a response to the challenge to predict an identity of the received drawn input;
determine whether the response is generated by a human based on a comparison of the predicted identity of the received drawn input to a character requested in the challenge; and
determining whether to grant access to a remote resource via the application executing at the edge device based on the determination of whether the response is generated by a human.

12. The method of claim 11, further comprising modifying the model to adapt a predicted identity corresponding to a drawn input to incorporate a consistent characteristic demonstrated in the received drawn input included in the response from a particular user that would, in the absence of the adaptation, result in a failure of the predicted identity to correspond to the character proposed in the challenge.

13. The method of claim 11, further comprising specifying, in the challenge, a portion of a user interface of the application executing at the edge device to be utilized to input the response.

14. The method of claim 13, further comprising transmitting, to the application executing at the edge device, instructions to cause the application executing at the edge device to:
determine whether the response is generated by the human based on a comparison of a portion of the user interface where the received drawn input was detected to the portion of the user interface specified to be utilized to input the response in the challenge.

15. The method of claim 11, further comprising generating, by the application executing at the edge device, a new challenge responsive to the predicted identity of the received drawn input not corresponding to a character proposed in the challenge.
